(19) United States
(12) Patent Application Publication
(10) Pub. No.: US 2026/0192860 A1
(43) Pub. Date: Jul. 9, 2026

(54) Vehicle Roof for a Motor Vehicle, and Arrangement

(71) Applicant: Bayerische Motoren Werke Aktiengesellschaft, Muenchen (DE)

(72) Inventors: Felix HALANG, Eberfing (DE); Daniel HAUPT-SCHOTT, Muenchen (DE); Robert HOFMANN, Scheyern (DE); Marco REISBOECK, Muenchen (DE)

(21) Appl. No.: 19/131,266

(22) PCT Filed: Jan. 12, 2024
(86) PCT No.: PCT/DE2024/100026

§ 371 Date: May 20, 2025

(30) Foreign Application Priority Data
Jan. 17, 2023 (DE) 10 2023 101 052.2

(51) Int. Cl. B62D 25/07; H01Q 1/32

(52) U.S. Cl. CPC B62D 25/07; H01Q 1/3275

(57) ABSTRACT

A vehicle roof for a motor vehicle includes a frame structure which has a roof cross member; a roof element which, when the vehicle roof is installed in the motor vehicle, has an outer side facing the surroundings of the motor vehicle; and a receiving space which is designed for positioning at least one antenna module and which is positioned in a front region of the vehicle roof in relation to a longitudinal direction of the motor vehicle. The receiving space is formed at least in part by a through-opening in the roof element and is positioned at least in part behind the roof cross member in the longitudinal direction of the motor vehicle, at least one stiffening element being positioned on the roof cross member.

### BACKGROUND AND SUMMARY

The invention relates to a vehicle roof for a motor vehicle. The invention also relates to the placement of at least one antenna module on the roof of a motor vehicle.

DE 10 2020 101 666 B3 discloses the placement of at least one antenna module on a vehicle roof in which the antenna module, which contains at least one antenna, is placed in a receiver delimited vertically at the bottom by a first roof element and covered at the top by a second roof element that forms a smooth outer surface of the vehicle roof.

DE 10 2011 106 829 A1 discloses an antenna assembly for a vehicle with a roof that can be opened, which contains at least one antenna located in a recess in a framework element for the roof, at least partially underneath an outer surface component of the vehicle. This antenna is located in the front lateral support of the roof framework bordering on the vehicle windshield.

The object of the invention is to create a vehicle roof for a motor vehicle and a placement of an antenna module in the roof of a vehicle, such that the antenna module functions reliably, and the rigidity of the roof can be substantially improved.

This is achieved by a vehicle roof for a motor vehicle and by a placement of an antenna module in the vehicle roof in accordance with the independent claims. Advantageous embodiments of the invention are the subject matter of the dependent claims and the description.

A first aspect of the invention relates to a vehicle roof for a motor vehicle. The motor vehicle can be a passenger automobile, a utility vehicle, or a truck. The motor vehicle preferably has a self-supporting body. The vehicle roof can be understood to be a roof for a motor vehicle body in particular. This roof can be understood to be a roof structure, in particular a vehicle body roof structure, or a roof system.

The vehicle roof has a least one framework, which can be referred to in particular as a roof frame or support frame. The framework has two lateral elements spaced apart over the length of the motor vehicle, and two longitudinal elements that are spaced apart over the width of the vehicle.

The framework has at least one lateral support. The lateral support preferably extends across the width of the vehicle in the assembled state of the roof. By way of example, a first lateral element forms the lateral support for the roof. The second lateral element forms a second individual lateral support for the roof. The first lateral support is at the front end of the roof in the assembled state. The first lateral support can form a windshield cowl. The second lateral support is at the back end of the roof.

The vehicle roof has at least one roof element, which is separate from the first and second lateral supports for the roof. This roof element is placed, at least indirectly or directly on the framework, specifically the first and/or second lateral supports. The roof element has at least one outer surface that faces toward the environment, i.e. facing upward, in the assembled state of the roof. The outer surface can be understood to be the outer surface of the vehicle roof. The vehicle roof is therefore at least partially, ideally entirely, delimited at the top, in particular toward the outside, by this roof element, in particular the outer surface of the roof element.

The vehicle roof has at least one receiving space, in particular for at least one antenna module. In other words, the antenna module is or can be placed, at least partially, or entirely, inside the receiving space. The antenna module is therefore inside the receiving space, in particular when the motor vehicle is fully assembled. In other words, the antenna module is or can be integrated in the vehicle roof, in particular in the receiving space therein.

The receiving space is near the front of the roof on the motor vehicle. In other words, the receiving space is in an area that is at least near the front lateral support for the roof.

The antenna module can be understood to be a communication device. The antenna module is preferably designed to transmit and/or receive signals. The antenna module is thus designed for signal transmission. By way of example, the antenna module has at least one antenna that is designed to receive and/or transmit signals. By way of example, information from the vehicle environment, e.g. from an infrastructure, other vehicles, cellular telephones, satellites, and/or radio transmissions, can be received and/or exchanged through the antenna module, specifically the antenna.

To ensure that the antenna module functions properly, in particular with regard to signal transmission, and to increase the rigidity of the vehicle roof, the receiving space, in particular the top thereof in the assembled state of the roof, is at least partially, in particular substantially or entirely, formed by an opening in the roof element. In other words, the roof element has a hole in it that is open toward the top of the roof, in particular in the assembled state of the roof on the motor vehicle, which is not covered by the roof element, and in particular by the first lateral support. This means that the receiving space is not covered by the roof element, and in particular by the lateral support in the assembled state of the roof on the motor vehicle. By way of example, the top of the receiving space is at least partially, ideally entirely, delimited by the opening. This opening can be understood to be a penetration or cut-out. The roof element therefore has a cut-out forming the opening. The opening could also form a recess, in particular for the antenna module.

The receiving space, in particular the antenna module, is at least partially, in particular substantially or entirely, behind the first lateral support for the roof. In other words, the receiving space, in particular the antenna module, is behind the first lateral support for the roof, in particular in the assembled state of the roof on the vehicle. The receiving space, in particular the antenna module, therefore extends backward, behind the first lateral support for the roof of the vehicle. In particular, the receiving space is at least partially, substantially, or entirely, behind the first lateral support for the roof. At least one reinforcing element is attached directly to the first lateral support. In other words, the first lateral support is reinforced by the reinforcing element. Moreover, the first lateral support is locally reinforced by the reinforcing element.

The reinforcing element can be understood to be a local supplementary reinforcement for the first lateral support of the roof. This means that the first lateral support is stiffer, because of the reinforcing element, than it would be without the reinforcing element, i.e. if there were no reinforcing element on the first lateral support for the vehicle roof. The reinforcing element is preferably a separate component, which is attached indirectly or directly to the first lateral support for the roof. This can be understood to be a supplementary reinforcing component, in particular for the first lateral support for the roof.

The invention is based, in particular, on the following insights and considerations. In theory, with a conventional vehicle roof, antenna modules can be attached to the body parts, thus forming “surface-mounted accessories.” This normally reduces headroom and/or the spaciousness perceived by vehicle occupants. A main load path, or one of the main load paths of the vehicle body, e.g. for numerous loads, may be found at the preferred location for where the antenna module is to be installed in the front part of the vehicle roof, in particular where the front lateral support is located. These loads include, e.g. a roof crush test, lateral collision, pole impact load, and/or vehicle rigidity. Furthermore, numerous components, such as sun-screens, absorbers, driver function modules and/or cable harnesses may already be attached to the lateral support in the form of a windshield cowl forming a body part of the motor vehicle. For this reason, it may be necessary to integrate the antenna module in the vehicle roof, in particular at the desired location. Furthermore, without an opening in the roof element, the functioning of the antenna module may be disrupted, or even prevented.

The roof obtained with the invention, in particular because of the opening in the roof element, ensures that the antenna module will function reliably. This means that signal transmission is ensured with regard to both sending and receiving signals. Because the reinforcing element is on the first lateral support for the roof, the rigidity of the first lateral support can be increased and improved. In particular, the load path for the roof crush test, lateral collision, pole impact load, and/or vehicle rigidity can be reduced locally to a minimum. The vehicle roof, or first lateral support, can be reinforced with the supplementary reinforcing element, such that a surface is formed that remains suitable for the aforementioned loads, despite massive constrictions. The reinforcing element is as small as possible, adding as little weight as possible to the vehicle. This means that the costs, in particular production costs, and/or weight of the vehicle roof, can be kept to a minimum. Because the receiving space is at least partially behind the first lateral support for the roof, the rigidity of the first lateral support can be increased, because it does not need to have a recess, in particular in the reinforcing element. Furthermore, the installation space for the antenna module in the vehicle roof can advantageously be kept small. The antennal module can be placed near the windshield of the motor vehicle with the roof obtained with the invention, in particular without disrupting or compromising the space or headroom available to the occupants of the vehicle. This improves the sense of spaciousness for the vehicle occupants, who can also be regarded as customers, for example. On the whole, it is clear that complex antenna modules can be integrated in the motor vehicle body, e.g. near the outer surface of the roof and/or the windshield cowl, with the vehicle roof obtained with the invention. In other words, the roof obtained with the invention results in a vehicle body structure in which the antenna module can be integrated.

In another embodiment, the opening is fully encircled by a wall on the roof element. This means that the wall forms a sheath encompassing the opening. In other words, the opening is entirely within the roof element. This separates the first lateral support for the roof, and in particular the reinforcing element, from the opening, i.e. the opening is preferably not within the first lateral support, and therefore not within the reinforcing element. This increases the rigidity of the vehicle roof. The antenna module can also then be efficiently placed in the vehicle roof without taking up much space. This wall preferably entirely or partially encompasses receiving space for the antenna module.

In another embodiment, the first lateral support and/or reinforcing element do not have an opening or recess for receiving the antenna module. In other words, the opening is formed exclusively in the roof element. In other words, no recess or opening is formed in the lateral support and/or reinforcing element for the antenna module. This allows for the rigidity of the vehicle roof, in particular the first lateral support and/or reinforcing element, to be substantially increased.

In another embodiment, the reinforcing element has at least one point where a conductive element for electrical signals transmitted between the antenna module and another component in the motor vehicle can be attached. In other words, this conductive element is or can be attached to the reinforcing element at this point. This means that the reinforcing element has at least one point where it can be attached to the conductive element. Consequently, the conductive element can be securely integrated in the vehicle roof without taking up much space, in that it is attached in particular to the vehicle roof, in particular the reinforcing element.

The conductive element is formed by a cable or cable harness, for example. The attachment point can therefore be understood to be a cable harness connection, or an integration in the cable harness connection. A cable harness for the antenna module can therefore be integrated in and attached to the vehicle roof. By way of example, the conductive element is clamped at the attachment point to the reinforcing element. This means that the conductive element can be clamped to the reinforcing element. The conductive element is intended for supplying electricity to the antenna module and/or transmitting information between the antenna module and other components.

In another embodiment, the roof element has at least attachment surface on which at least one cover element, formed separately from the roof element and/or framework, can be placed. In other words, the cover element can be attached directly or indirectly to the roof element at the attachment surface. The cover element covers the receiving space, in particular the opening, in particular in the assembled state of the roof on the motor vehicle, at the top of the vehicle, at least in part, in particular substantially or entirely. In other words, the receiving space, or opening, is at least partially, in particular substantially or entirely, closed at the top by the cover element in the assembled state of the roof on the motor vehicle. This allows for the receiving space, and in particular the opening, to be securely sealed, in particular against water and/or dust. This results in a clean space for a supplementary acoustic seal.

The cover element can be referred to as a screen, cover shield, or antenna cover. The attachment surface forms a bonding surface, for example.

In another embodiment, the roof element has a least one contour. In other words, the roof element is contoured, in particular locally. This contour can form a step with a defined shape in a thin-walled component. This increases the rigidity of the roof element. This contour can also allow for numerous supplementary functions, which shall be explained in greater detail below.

By way of example, the attachment surface may be formed at least in part, in particular substantially or entirely, by the contour. In other words, the contour at least partially forms the attachment surface. This attachment surface therefore forms a contoured surface. This allows for a water-tight and/or dust-proof connection, in particular with an adhesive, between the cover element and the roof element. This means that the contour forms at least one adhesive surface and/or sealing surface.

In another embodiment, the opening is formed entirely within the contoured surface. In other words, the opening is entirely within the contoured surface. This means that the opening is entirely surrounded, in particular radially, by the contoured surface. This further increases or improves the rigidity of the roof element, despite the opening.

The vehicle roof can also have at least one drain through which water can flow in the contoured surface, with which water on or in the roof element can be removed. Consequently, water can be removed from the roof element without additional components. This protects the antenna module from moisture. By way of example, water can be removed from the roof element and released into the environment through the drain.

It should be clear that the contoured surface is designed to allow for supplementary functions, e.g. in the form of a attachment surface, and/or opening, and/or water drain. In particular, the contoured surface is thus designed to facilitate the functioning of the antenna module.

In another embodiment, the roof element is separate from the framework and connected directly or indirectly to the framework, in particular the first lateral support. The roof element preferably extends over the entire length and width of the roof in the assembled state on the motor vehicle. In other words, the roof element forms the outer surface of the vehicle roof. Consequently, the antenna module can be advantageously accommodated in a design of the motor vehicle in which the motor vehicle has a normal roof, preferably without a glass roof. This roof element is made of metal.

The roof element can also be part of the framework. In other words, the framework includes the roof element. This means that the frame for the roof is formed at least in part by the roof element. By way of example, there is at least one glass element in the framework, forming a glass roof. This means that in one embodiment, in which the motor vehicle has a glass roof, the antenna module can be advantageously accommodated in the vehicle roof. This means that with a glass roof system, there is no outer surface of the roof, and the antenna module can be placed in the framework for the glass roof system.

A second aspect of the invention relates to placing at least one antenna module in a roof for a motor vehicle. Advantages and advantageous embodiments of the first aspect of the invention are to be regarded as advantages and advantageous embodiments of the second aspect of the invention, and vice versa.

In one assembly, the antenna module is at least substantially or entirely placed in a receiving space in the front of the vehicle roof. The vehicle roof has at least one framework with a lateral support. The vehicle roof also has at least one roof element, which has an outer surface facing toward the environment in the assembled state of the roof on the motor vehicle.

To ensure that the antenna module functions properly, and to increase the rigidity of the vehicle roof, the invention provides that the receiving space is formed at least in part by an opening in the roof element, which is at least partially, ideally substantially, behind the lateral support, on which there is at least one reinforcing element.

Another aspect relates to a motor vehicle, which has a roof according to the first aspect of the invention. Advantages and advantageous embodiments of the first and second aspects of the invention are to be regarded as advantages and advantageous embodiments of this other aspect, and vice versa.

Further features of the invention can be derived from the claims, drawings, and descriptions thereof. The features and combinations of features specified above, as well as the features and combinations of features specified in the descriptions of the drawings can be used not only in the respective combinations specified herein, but also in other combinations or in and of themselves.

Preferred exemplary embodiments of the invention shall be described in greater detail below in reference to the drawings.

### BRIEF DESCRIPTION OF THE DRAWINGS

FIG. 1 is a schematic illustration of an embodiment of the vehicle roof according to the invention in an assembly, from above;

FIG. 2 is a schematic detailed view of the vehicle roof in an assembly, from above;

FIG. 3 is a schematic cutaway view of the vehicle roof in an assembly;

FIG. 4 is a schematic and perspective partial view of the vehicle roof in an assembly;

FIG. 5 is another schematic and perspective partial view of the vehicle roof in an assembly;

FIG. 6 is a schematic and perspective partial view of the vehicle roof in an assembly;

FIG. 7 is a schematic and perspective view of a motor vehicle body with the roof, to illustrate a load flow;

FIG. 8 is a schematic cutaway view of the vehicle roof in an assembly;

FIG. 9 is a schematic view of another embodiment of the vehicle roof in an assembly from above; and

FIG. 10 is a schematic detail of FIG. 9.

Identical or functionally identical elements have the same reference symbols in the drawings.

### DETAILED DESCRIPTION OF THE DRAWINGS

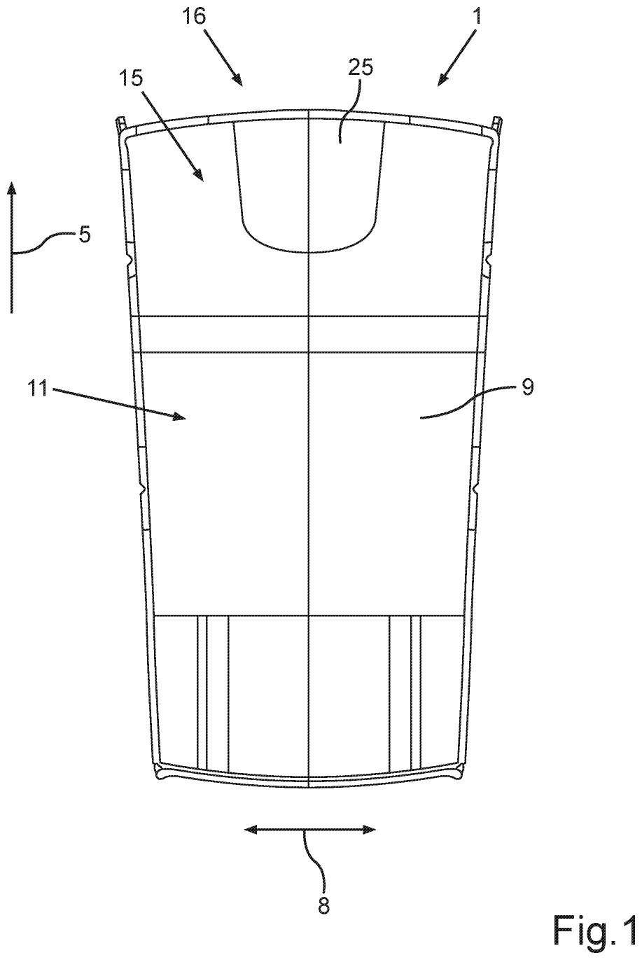

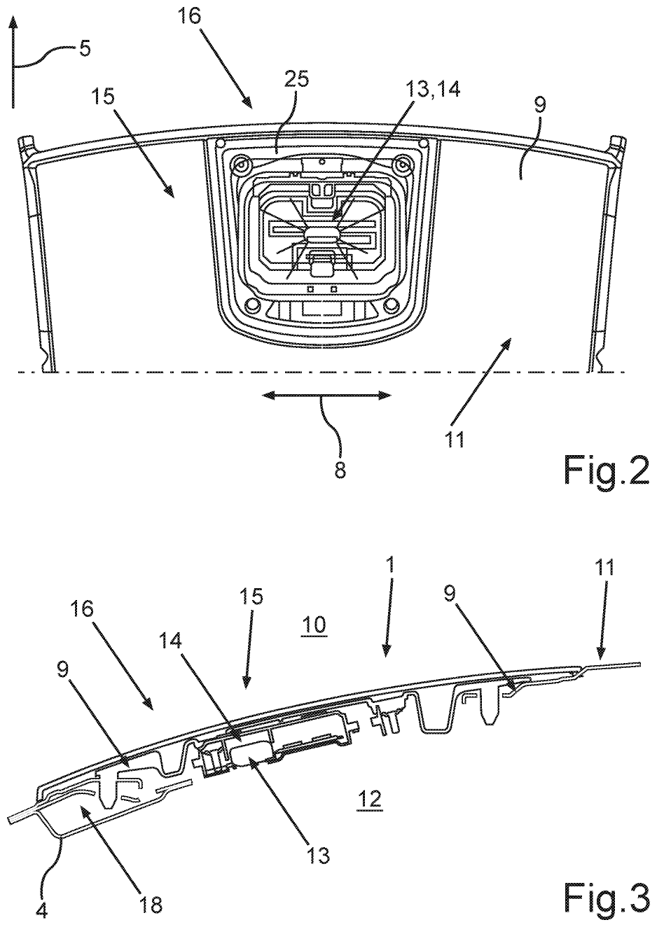

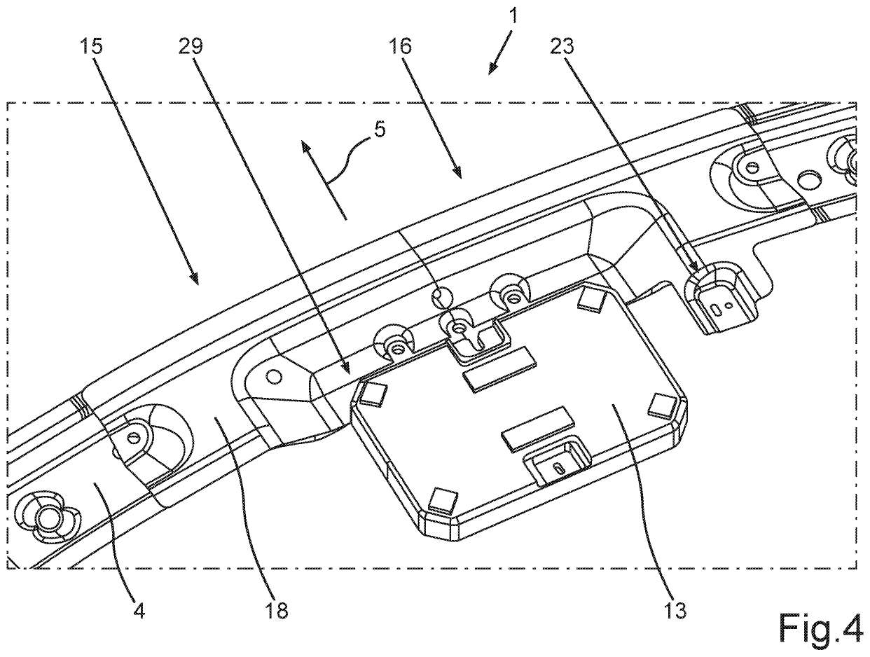

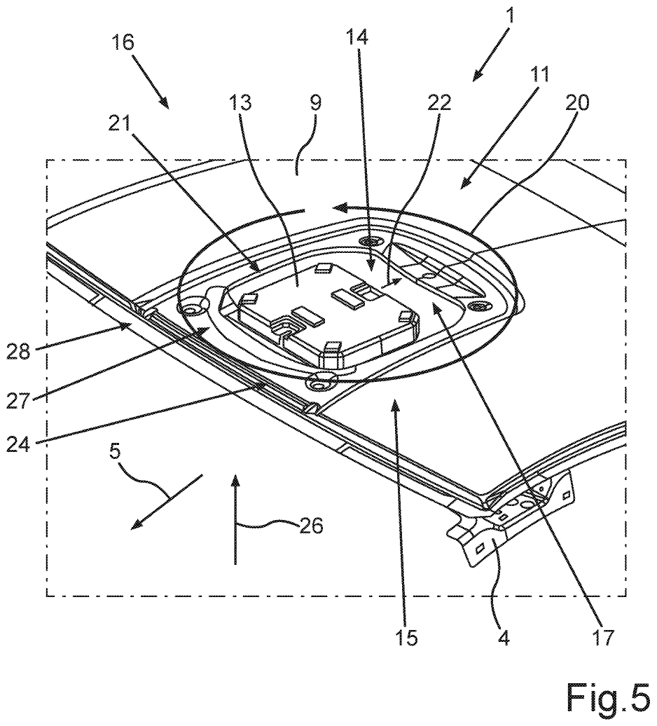

FIG. 1 shows a schematic illustration of a vehicle roof 1 for a motor vehicle from above. FIG. 2 shows a schematic detail of the illustration in FIG. 1. FIG. 3 shows a schematic cutaway view of the vehicle roof 1. FIGS. 4, 5 and 6 show sectional views of the vehicle roof 1 from different perspectives.

FIG. 7 shows a schematic and perspective partial view of the body 2 of a motor vehicle. The vehicle roof 1 is preferably part of the vehicle body 2. The roof 2 has a framework 3 with a lateral support, which can be referred to in particular as the first lateral support 4 or the front lateral support 4. This framework 3 has a separate, second lateral support, not shown in FIGS. 1 to 7, which can be referred to as the back lateral support. The first lateral support 4 is preferably in front of the second lateral support over the length 5 of the motor vehicle. The framework 3 can have two longitudinal supports 6, 7, which are spaced apart over the width 8 of the motor vehicle. The first longitudinal support 6 can be on one side of the motor vehicle, and the second longitudinal support 7 can be on the other side. The first longitudinal support 6 is therefore on the left side, and the second longitudinal support 7 is on the right. The lateral supports 4 are preferably connected by the longitudinal supports 6, 7. The first lateral support 4 in this exemplary embodiment forms a windshield cowl.

The vehicle roof 1 has a roof element 9 with an outer surface 11 facing the environment 10 in the assembled state of the roof 1 on the motor vehicle. This outer surface 11 therefore faces away from the interior 12 of the motor vehicle. The interior 12 can be referred to as the passenger compartment. The interior 12 contains at least one passenger when the vehicle is travelling.

The vehicle roof 1 has at least one receiving space 14 for an antenna module 13 in the front part 15 of the roof. The front part 15 is the front end of the vehicle roof 1 over the length 5 of the vehicle, specifically the front of the roof element 9. FIGS. 1 to 7 therefore show schematic illustrations of the placement 16 of the antenna module 13 in the roof 1 of the motor vehicle.

To ensure that the antenna module 3 functions properly, and to increase the rigidity of the vehicle roof 1, the receiving space 14 is at least partially, in particular substantially or entirely, formed by an opening 17 in the roof element 9 behind the first lateral support 4, which has at least one reinforcing element 18 placed directly on it. The opening 17 is formed by a recess or cut-out in the roof element 9, in particular the outer surface 11 thereof, to accommodate the antenna module 13, such that it can reliably transmit and receive signals.

A load path, e.g. in the event of a collision, is indicated in FIG. 7 by arrows 19. The reinforcing element 18 reinforces the vehicle body 2. This load path may be advantageous in the event of a collision, in particular when the load to the vehicle body 2, specifically the roof 1, is particularly low. This reinforcing element 18 can be regarded as a reinforcement in the event of a collision, in particular. Specifically, the reinforcing element 18 reinforces the roof 1, in particular the first lateral support 4 thereof, in order to withstand various loads. The first lateral support 4 and the reinforcing element 18 are preferably designed for another.

In another embodiment, the opening 17 is entirely encompassed by a wall 21 in the roof element 9 over its circumference 20. This wall 21 preferably at least partially, ideally entirely, delimits the opening 17 over the radial direction 22. By way of example, the wall 21 fully encompasses the receiving space 14 over its circumference. The circumferential direction of the receiving space 14 preferably corresponds to the circumferential direction 20 of the wall 21.

The opening for the antenna module 13 is preferably not formed in any part of the first lateral support 4 or reinforcing element 18 in this exemplary embodiment. In other words, there is no cut-out in the first lateral support 4 or the reinforcing element 18, in particular for the antenna module 13, specifically such that the opening 17 for the antenna module 13 is formed only in the roof element 9.

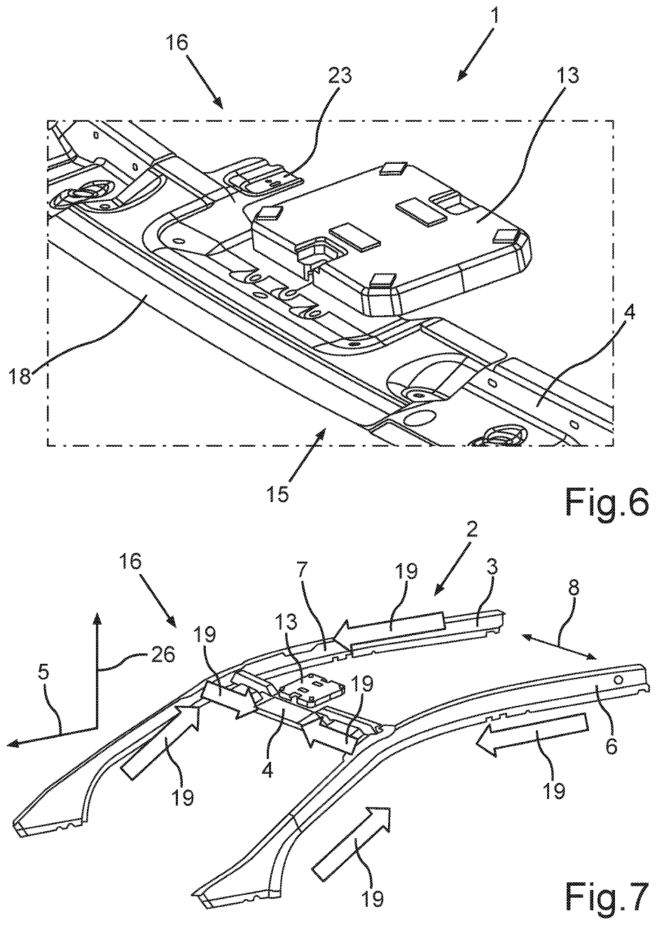

There is at least one attachment point 23 on the reinforcing element 18 in the exemplary embodiment in FIGS. 4 and 6, to which an electrically conductive element is attached for transmitting signals between the antenna module 13 and another component in the motor vehicle. The conductive element is formed by a cable or cable harness. This conductive element is preferably clamped to the attachment point 23 on the reinforcing element 18, in particular on the vehicle roof 1. The conductive element is therefore clamped to the reinforcing element 18 at the attachment point 23. The attachment point 23 forms a flange in the exemplary embodiment shown in FIGS. 4 and 6.

In another embodiment, the roof element 9 has at least one attachment surface 24 with at least one cover element 25, which substantially or entirely covers the top of the opening 17. The antenna module 13 is therefore underneath the cover element 25 along the vertical axis 26. The cover element 25 is transparent in FIG. 2, leaving the antenna module 13 visible in FIG. 2.

The cover element 25 can be glued directly or indirectly to the roof element 9 at the attachment surface 24. This adhesive is preferably water-tight and/or impermeable to dust. This means that the attachment surface 24 has a sealing surface that seals the roof element 9 with the cover element 25 against water and/or dust. By way of example, at least one seal is placed on the attachment surface 24 that seals the roof element 9 and cover element 25 against water and/or dust in the vehicle environment 1.

The vehicle roof 1 can have a second cover element that at least partially, ideally substantially or entirely, covers or delimits the receiving space 14 at the bottom. This second cover element is therefore below the antenna module 13 along the vertical axis 26. The second cover element is preferably connected directly or indirectly to the first lateral support 4 and/or the roof element 9.

The front of the receiving space 14 can be at least partially delimited or formed by the first lateral support 4 and/or the reinforcing element 18. By way of example, the antenna module 13 is at least partially placed inside the opening 17, and/or the antenna module 13 is at least partially, in particular entirely, underneath the opening 17.

In the exemplary embodiment shown in FIGS. 1 and 7, the roof element 9 has at least one contour 27. This attachment surface 24 is preferably formed, at least in part, by the contour 27. The opening 17 is preferably at least partially, in particular entirely, within the contour 27. The vehicle roof 1 preferably has at least one drain 28 through which water can flow, which is at least partially formed by the contour 27, with which water can be conducted away from the roof element 9.

In the exemplary embodiment shown in FIGS. 4 and 6, the reinforcing element 18 and/or first lateral support 4 each have a recess 29. This recess 29 is formed by stamping, and can be regarded as a second contour. The reinforcing element 18 and/or first lateral support thus have a respective first section and a second section that forms the recess 29. By way of example, the recess 29 on the reinforcing element 18 is formed below part of the antenna module 19. Consequently, the antenna module 13 is partially on top of the recess 29 in the reinforcing element 18. In other words, the bottom of the receiving space 14 is partially delimited by the reinforcing element 18, in particular the recess 29 in the reinforcing element 18. This recess 29 increases the rigidity of the reinforcing element 18 and/or the first lateral support 4. This allows the antenna module 13 to be placed in the vehicle roof 1 in a space-saving manner, in particular without needed to make a cut-out in the reinforcing element 18 and/or the first lateral support 4.

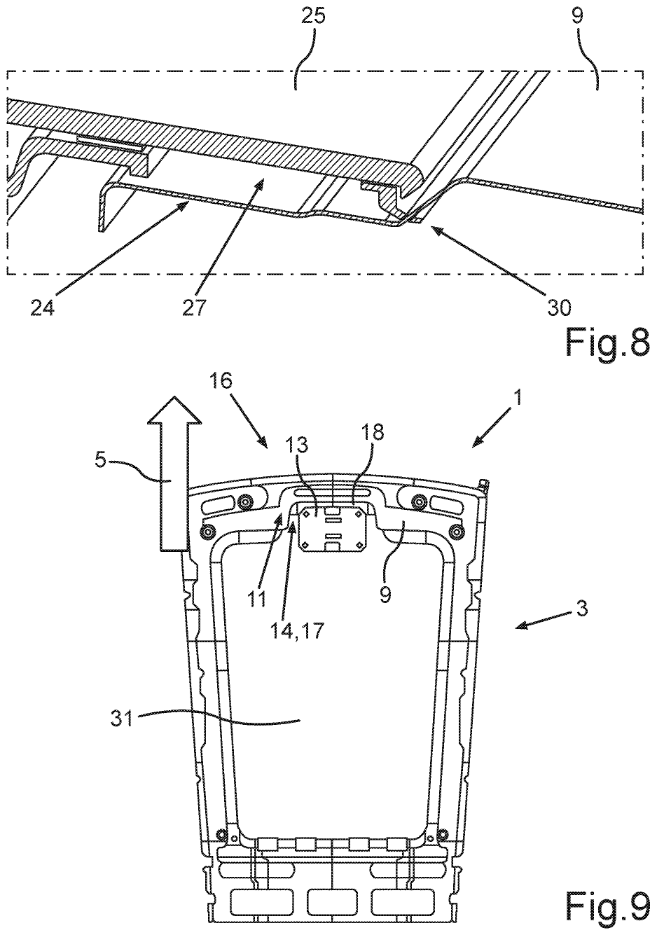

FIG. 8 shows a schematic, cutaway illustration of the vehicle roof 1. There is a second sealing surface 30 for a second, supplementary sealing element, which is different than the attachment surface 24, in the exemplary embodiment shown in FIG. 8. The second sealing element is placed directly on the second sealing surface 30. By way of example, the second sealing element is in direct contact with the roof element 9 and the cover element 25. The second sealing element forms a supplementary acoustic seal. By way of example, the second sealing surface 30 is formed at least in part, in particular substantially or entirely, by the contour 27. This contour 27 results in a clean bearing surface for the supplementary acoustic seal on the cover element 25.

The roof element 9 in the exemplary embodiment shown in FIGS. 1 to 8 has a separate framework 3. In this case, the roof element 9 forms an outer layer. The vehicle roof 1 in the exemplary embodiment shown in FIGS. 1 to 8 is therefore a normal vehicle roof. This means that the vehicle does not have a glass roof, and the roof 1 is at least substantially made of a material other than glass. This material is metal, for example.

The roof element 9 extends substantially through or over the roof 1 in the exemplary embodiment shown in FIGS. 1 to 8. This means that the length of the roof element 9 extends at least substantially over the entire length of the vehicle roof 1, and/or the width of the roof element 9 extends at least substantially over the entire width of the vehicle roof 1. The length of the roof element 9 and overall length of the vehicle roof 1 preferably extend along the length 5 of the vehicle. The width of the roof element 9 and overall width of the vehicle roof 1 preferably extend over the width 8 of the vehicle.

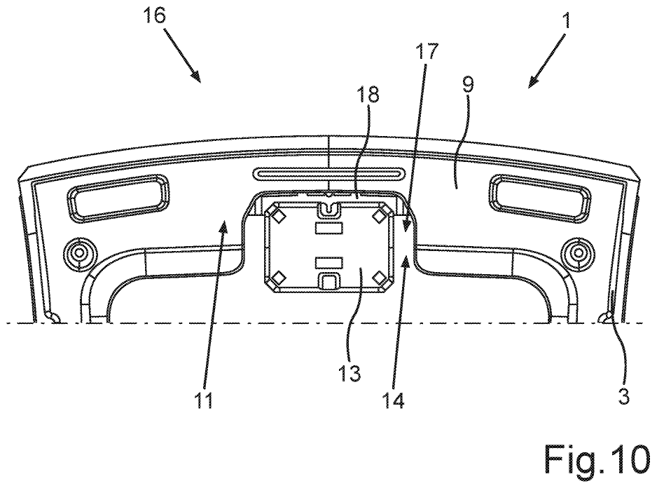

FIGS. 9 and 10 show another embodiment of the vehicle roof 1. The roof 1 is shown schematically from above in FIG. 9. The vehicle roof 1 is shown schematically in a sectional view from above in FIG. 10. In the embodiment shown in FIGS. 9 and 10, the motor vehicle has a glass roof. The glass roof is not shown in FIGS. 9 and 10.

The roof element 9 in the embodiment shown in FIGS. 9 and 10 is part of the framework 3. By way of example, the roof element 9 is at least partially or entirely made of metal. The framework 3, which can be referred to as the roof framework system, is connected to the glass roof by the roof element 9, in particular at least indirectly or directly. In the exemplary embodiment shown in FIGS. 9 and 10, the roof element 9 has an opening 31, which differs from the opening 17 in the other exemplary embodiment, which is entirely covered by the glass roof. The opening 17, and thus the receiving space 14, is also covered. The opening 31 preferably extends over the surface of the vehicle roof 1. This means that the length of the opening 31 extends at least substantially over the entire length of the vehicle roof 1, and/or the width of the opening 31 extends at least substantially over the entire width of the vehicle roof 1. The length of the opening 31 and overall length of the vehicle roof 1 preferably extend along the length 5 of the vehicle. The width of the opening 31 and the overall width of the vehicle roof 1 preferably extend over the width 8 of the vehicle.

Because the opening 31 extends over the surface of the vehicle roof 1, a glass roof system can be installed in the motor vehicle, through which the vehicle occupants can see. As FIGS. 9 and 10 show, the antenna module 13 is placed in a cut-out in the framework 3, in particular at least in part or entirely.

Numberings, e.g. “first,” “second,” “third,” etc. are only used to differentiate, and do not indicate any sequence. This means that these numberings could be arbitrarily exchanged between one another.

### LIST OF REFERENCE SYMBOLS

1 vehicle roof
2 vehicle body
3 framework
4 first lateral support
5 longitudinal direction of the vehicle
6 first longitudinal support
7 second longitudinal support
8 lateral direction of the vehicle
9 roof element
10 environment
11 outer surface
12 interior
13 antenna module
14 receiving space
15 front area
16 placement
17 opening
18 reinforcing element
19 arrow
20 circumferential direction
21 wall
22 radial direction
23 attachment point
24 attachment surface
25 cover element
26 vertical axis
27 contour
28 water drain
29 recess
30 second sealing surface
31 opening

1.-10. (canceled)

11. A vehicle roof for a motor vehicle, comprising:
a framework with a lateral support;
at least one reinforcing element attached to the lateral support;
a roof element that has an outer surface facing outward toward an environment in an assembled state of the vehicle roof; and
a receiving space for an antenna module, which is in a front part of the vehicle roof in relation to a longitudinal direction of the vehicle,
wherein the receiving space is formed at least in part by an opening in the roof element, and is at least partially behind the lateral support, to which the at least one reinforcing element is attached, in the longitudinal direction of the vehicle.

12. The vehicle roof according to claim 11, wherein
the opening is entirely encompassed in its circumferential direction by at least one wall on the roof element over the circumference of the opening.

13. The vehicle roof according to claim 11, wherein there are no openings for the antenna module in the lateral support and the reinforcing element.

14. The vehicle roof according to claim 11, wherein
the reinforcing element has at least one attachment point to which at least one conductive element is attached for transmitting signals between the antenna module and at least one other component in the motor vehicle.

15. The vehicle roof according to claim 11, wherein
the roof element has at least one attachment surface on which at least one cover element is placed that at least partially covers the receiving space at the top.

16. The vehicle roof according to claim 11, wherein the roof element has at least one contour.

17. The vehicle roof according to claim 16, wherein the attachment surface is formed at least in part by the contour.

18. The vehicle roof according to claim 17, wherein
the opening is inside the contour, and/or
the vehicle roof has at least one drain through which water can flow, formed at least in part by the contour, with which water can be removed from the roof element.

19. The vehicle roof according to claim 11, wherein the roof element is separate from the framework, or is part of the framework.

20. A method of placing an antenna module in a vehicle roof on a motor vehicle, comprising:
placing the antenna module in a receiving space in a front part of the vehicle roof in relation to a longitudinal direction of the vehicle, which vehicle roof has a framework with a lateral support and a roof element, with an outer surface facing the environment of the motor vehicle; and
forming the receiving space at least in part by an opening in the roof element, the receiving space being at least partially behind the lateral support in the longitudinal direction of the vehicle, on which at least one reinforcing element is placed.
